(19) United States
(12) Patent Application Publication
(10) Pub. No.: US 2022/0091896 A1
(43) Pub. Date: Mar. 24, 2022

(54) HYBRID CLOUD DELIVERY TELEMETRY ENGINE

(71) Applicant: JPMORGAN CHASE BANK, N.A., New York, NY (US)

(72) Inventor: John S. COMBS, Fallston, MD (US)

(21) Appl. No.: 17/481,581

(22) Filed: Sep. 22, 2021

Related U.S. Application Data
(60) Provisional application No. 63/081,477, filed on Sep. 22, 2020.

(51) Int. Cl. G06F 9/50; G06F 21/31

(52) U.S. Cl. CPC G06F 9/5055; G06F 9/5077; G06F 9/5072; G06F 2221/2111; G06F 2209/508; G06F 2209/503; G06F 2221/2141; G06F 21/31

(57) ABSTRACT

Hybrid cloud delivery telemetry engines are disclosed. In one embodiment, in an information processing apparatus comprising at least one computer processor, a method for hybrid cloud delivery telemetry may include: (1) receiving, at a user portal, a user identifier, wherein the user identifier is associated with a set of entitlements for patterns, resources, and services to which the user is authorized to access; (2) retrieving based on the user identifier, a pattern, a resource, and a service available to the user based on the user identifier; (3) presenting the available pattern, resource, and service to the user for selection; (4) receiving, at the user portal, a selection of at least one of the pattern, the resource, and the service from the user; and (5) provisioning a user-specific system based on the selection of at least one of the pattern, the resource, and the service.

### RELATED APPLICATIONS

This application claims priority to, and the benefit of, U.S. Provisional Patent Application Ser. No. 63/081,477, filed Sep. 22, 2020, the disclosure of which is hereby incorporated, by reference, in its entirety.

### BACKGROUND OF THE INVENTION

### 1. Field of the Invention

The present disclosure generally relates to a hybrid cloud delivery telemetry engine.

### 2. Description of the Related Art

As organizations move toward a multi-cloud architecture and hybrid cloud strategy, difficulties arise with how to how to expose certain data elements and information within a public cloud environment. The end user (e.g., a software engineer) is usually tasked with managing with a large subset of data across multiple cloud providers (e.g., Azure, AWS, GAIA, Google), each of which has its own environment information, incidents, and provisioning details. This can quickly become overwhelming.

### SUMMARY OF THE INVENTION

Hybrid cloud delivery telemetry engines are disclosed. In one embodiment, a method for hybrid cloud delivery telemetry may include: (1) receiving, by a computer program and from a user portal, a user identifier for a user, wherein the user identifier is associated with a set of entitlements for a plurality of patterns, a plurality of resources, and a plurality of services to which the user is authorized to access for a project; (2) retrieving, by the computer program and based on the user identifier, a subset of the plurality of patterns, a subset of the plurality of resources, and a subset of the plurality of services available to the user based on the set of entitlements associated with the user identifier; (3) presenting, by the computer program, the subset of the plurality of patterns, the subset of the plurality of resources, and the subset of the plurality of services to the user for selection; (4) receiving, by the computer program and from the user portal, a selection of one of the patterns, one of the resources, and/or one of the services from the user; and (5) provisioning, by the computer program, a user-specific system based on the selected pattern, the selected resource, and/or the selected service.

In one embodiment, the user identifier may be further associated with a geography or region.

In one embodiment, the method may further include receiving, by the computer program, a selection of resource attributes for the selected resource.

In one embodiment, the method may further include receiving, by the computer program, a selection of authorized users or groups for onboarding. The authorized users or groups may be granted access to the user-specific system.

In one embodiment, the method may further include generating, by the computer program, a cost estimate for the selected resources; and receiving, by the computer program, approval for the cost estimate. The approval may be received before the user-specific system is provisioned.

In one embodiment, the step of provisioning the user-specific system based on the selected pattern, the selected resource, and/or the selected service may include: initiating, by the computer program, interactions with data center systems and/or cloud systems to provision the selected pattern, the selected resource, and/or the selected service; creating, by the computer program, projects for the selected pattern in response to the pattern being selected; creating, by the computer program, a development pipeline that is linked to the project; associating, by the computer program, the project with a financial telemetry tool to monitor costs for the project; authorizing, by the computer program, the user to access the user-specific system; onboarding, by the computer program, the selected pattern, the selected resource, and/or the selected service; provisioning, by the computer program, the onboarded resources and deploying the onboarded pattern; making, by the computer program, the provisioned resources and at least one account available for discovery; and monitoring, by the computer program, use of the user-specific system.

According to another embodiment, an electronic device may include: a memory storing a computer program and a computer processor. When executed by the computer processor, the computer program causes the computer processor to: receive, from a user portal, a user identifier for a user, wherein the user identifier is associated with a set of entitlements for a plurality of patterns, a plurality of resources, and a plurality of services to which the user is authorized to access for a project; retrieve, based on the user identifier, a subset of the plurality of patterns, a subset of the plurality of resources, and a subset of the plurality of services available to the user based on the set of entitlements associated with the user identifier; present the subset of the plurality of patterns, the subset of the plurality of resources, and the subset of the plurality of services to the user for selection; receive, from the user portal, a selection of one of the patterns, one of the resources, and/or one of the services from the user; and provision a user-specific system based on the selected pattern, the selected resource, and/or the selected service.

In one embodiment, the user identifier may be further associated with a geography or region.

In one embodiment, the computer program may further cause the computer processor to receive a selection of resource attributes in response to the resource being selected.

In one embodiment, the computer program may further cause the computer processor to receive a selection of authorized users or groups for onboarding. The authorized users or groups may be granted access to the user-specific system.

In one embodiment, the computer program may further cause the computer processor to: generate an estimate for the selected resources; and receive approval for the estimate. The approval may be received before the user-specific system is provisioned.

In one embodiment, the computer program causes the computer processor to provision the user-specific system based on the selection of the pattern, the resource, and/or the service by causing the computer processor to: initiate interactions with data center systems and/or cloud systems to provision the selected pattern, the selected resource, and/or the selected service; create projects for the selected pattern in response to the pattern being selected; create a development pipeline that is linked to the project; associate the project with a financial telemetry tool to monitor costs for the project; authorize the user to access the user-specific system; onboard the selected pattern, the selected resource, and/or the selected service; provision the onboarded resources and deploying the onboarded pattern; make the provisioned resources and at least one account available for discovery; and monitor use of the user-specific system.

According to another embodiment, a system may include an entitlements library comprising a plurality of user identifiers, each user identifier associated with a set of entitlements for a plurality of patterns, a plurality of resources, and a plurality of services that the user identifier is authorized to access for a project; a pattern library comprising a plurality of patterns; a resource library comprising a plurality of resources; a services library comprising a plurality of services; a user portal that: receives a user identifier, retrieves the set of entitlements that are associated with the user identifier from the entitlements library; retrieves the plurality of patterns, the plurality of resources, and the plurality of services associated with the set of entitlements from the pattern library, the resource library, and the services library, respectively; present the plurality of patterns, the plurality of resources, and the plurality of services to the user for selection; and receives a selection of one of the patterns, one of the resources, and/or one of the services from the user; and a computer program executed by a computer processor that causes the computer program to provision a user-specific system based on the selected pattern, the selected resource, and/or the selected service.

In one embodiment, the user identifier may be further associated with a geography or region.

In one embodiment, the computer program may further cause the computer processor to receive a selection of resource attributes in response to the resource being selected.

In one embodiment, the computer program may further cause the computer processor to receive a selection of authorized users or groups for onboarding. The authorized users or groups are granted access to the user-specific system.

In one embodiment, the computer program may further cause the computer processor to generate an estimate for the selected resources; and receive approval for the estimate. The approval may be received before the user-specific system is provisioned.

In one embodiment, the computer program may cause the computer processor to provision the user-specific system based on the selection of the pattern, the resource, and/or the service by causing the computer processor to: initiate interactions with data center systems and/or cloud systems to provision the selected pattern, the selected resource, and/or the selected service; create projects for the selected pattern in response to the pattern being selected; create a development pipeline that is linked to the project; associate the project with a financial telemetry tool to monitor costs for the project; authorize the user to access the user-specific system; onboard the selected pattern, the selected resource, and/or the selected service; provision the onboarded resources and deploying the onboarded pattern; make the provisioned resources and at least one account available for discovery; and monitor use of the user-specific system.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts an exemplary hybrid cloud delivery telemetry engine according to one embodiment;

FIG. 2 depicts a system for providing intelligent-based end-to-end delivery for an application according to one embodiment; and

FIG. 3 depicts an exemplary method for hybrid cloud delivery telemetry according to one embodiment.

### DETAILED DESCRIPTION OF PREFERRED EMBODIMENTS

Embodiments are directed to hybrid cloud delivery telemetry engines. In one embodiment, a multi-cloud architecture to achieve telemetric end-to-end delivery of identity, authorization, authentication, and unification in a hybrid environment is disclosed. Embodiments may automatically aggregate, monitor, and configure multiple sources of fragmented data and environment information across incidents and regions to create a normalized experience for end users in the cloud.

Embodiments may combine multiple sources of data (e.g., architecture, tools and automation, and experience management), environment information, incidents, and enrollments for the end user. Embodiments may create an infrastructure to abstract and configure the front-end solution for a contextualized view into the applications an end user has access to while contributing to a simplified provisioning experience within a public cloud framework (i.e., provider options, region, spend, cost, etc.).

Embodiments may use artificial intelligence to eliminate or remove distractions to identify the most important tasks. For example, the system may know the user, and the applications that the user is interested in; artificial intelligence may identify applications that require your user action and may alert the user with, for example, a subtle annotation; artificial intelligence may scan incidents, problems, change, deployments, resource configurations, risks and other processes to determine the most important items, and may alert the user through, for example, simple actionable headlines; and key processes of counts of additional open items requiring attention may be surfaced through, for example, consistent annotated iconography.

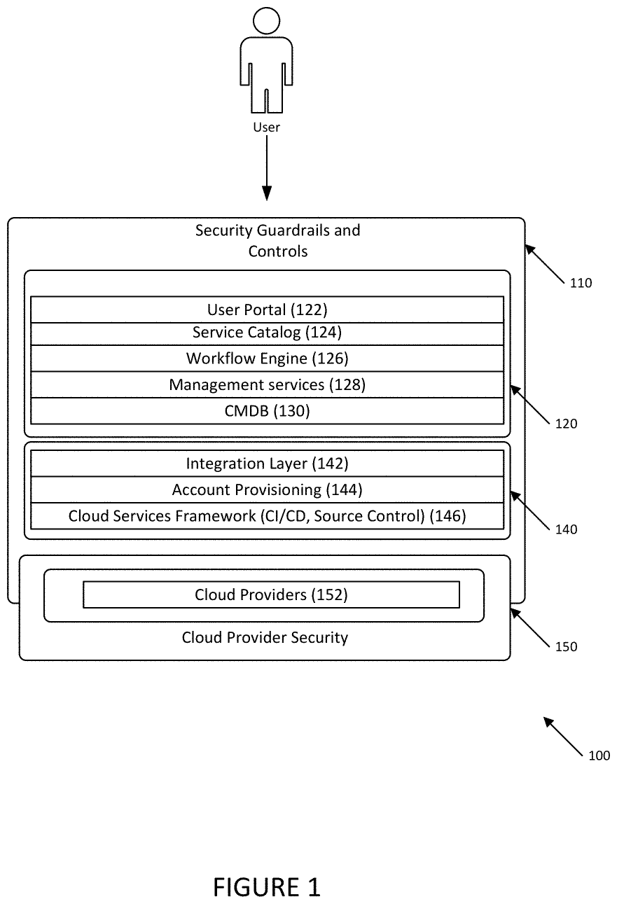

Referring to FIG. 1, a high-level diagram of a system for hybrid cloud delivery telemetry is disclosed according to one embodiment. System 100 may include security guardrails and controls 110, which may include layer 120. In one embodiment, layer 120 may be considered to be the convergence of two or more of reference data, people, assets, configuration items, entitlements, operational characteristics, application data, relationships, etc. with a unified channel of engagement (e.g., a portal, pipeline, etc.).

Layer 120 may include user portal 122, service catalog 124, workflow engine 126, service management, operations and SLA management, management services 128, and configuration management database (CMDB) 130. User portal 122 may include an omni-channel engagement, portal, automation pipeline, etc. User portal 122 may provide a unified, consistent immersive experience to the consumer. In one embodiment, user portal 122 may be a self-service portal.

Service catalog 124 may be a feature rich catalog that house services and assets for consumer consumption. For example, it may include patterns such as cloud patterns, application patterns, ready-made environments, etc.

Workflow engine 126 may be the point at which the orchestration and aggregation of data, controls, policy etc. converges to provide an intuitive simplified consumer experience while in the background, provides deep transparency of all steps in the transaction, e.g. approvals, technical controls, financial controls, compliance, operational controls, etc.

Management services 128 may define service level agreements and make them fully transparent by service/asset, along with full transparency into spend, utilization, forecasting, predictive insights, etc.

CMDB 130 may house low-level configuration items that ultimately relay to the delivery of an application and/or service. Examples include servers, compute, storage, firewall config, services, load balancers, etc.

Layer 140 is a layer at which services and/or assets are invoked/instantiated. In one embodiment, provisioning across multi-cloud or on-premises may occur in layer 140.

Layer 140 may include integration layer 142, account provisioning layer 144, and could services framework 146.

Cloud provider security 150 may include cloud providers 152. In one embodiment, security controls, policies, and enforcement rules may be are managed centrally and invoked in each cloud provider 152. This creates a single view and consistency across the cloud providers.

Embodiments may provide a cloud-agnostic user experience with common taxonomies; may offer flexibility to experiment in multiple cloud environments; may enable a consistent experience for various personas (e.g., developer, financial analyst, compliance officer, etc.); may provide access to best-in-class provider agnostic cloud management and operations tools; may provide a transparent view of to-date and projected costs at the device and hourly levels; may allow application teams to deploy infrastructure into continuous integration/continuous development (CI/CD) pipelines; may leverage leverage-leading edge services, such as natural language processing, big data analytics, and AI; and may be the system of record for cloud configuration management database (CMDB) that supports request and incident processes as well as support “Get to Moderate” (GtM) goals and objectives.

Embodiments may deploy a unified identity and access Management approach for cloud by tapping into Azure Active Directory for common Role-Based Access Controls (RBAC) definitions across clouds; may enable the cloud as an extension of on-premises infrastructure with privately routable networks, trusted environments to connect to existing resources; may provide a calibrated environment for teams to prototype and experiment through continuous security monitoring; may implement security controls at an infrastructure layer; may provide a progressively-hardened environments to promote learning and development while protecting production assets (e.g., a sandbox environment to provide hands-on access to promote learning and experimentation; development environment with scoped access to support efficient development and debugging and continuous integration; and a UAT/Production environment that provides hands-off, immutable, and hardened security in upper environments to protect corporate assets); and a corporate standard VPC that provides rapid delivery in a secure zone architecture.

In embodiments, a cloud toolchain may implement automation to interact, request, and track changes within the organization that may reduce time to market. It may provide a rich set of template libraries; application stacks and deployment strategies empower users to select a predefined solution rather than developing one. It may provide flexibility for application teams to interact with cloud consoles and create new services in a controlled, connected environment. It may use cost, time-to-market, and scalability efficiencies of the cloud, and may aggregate disparate application and project request processes.

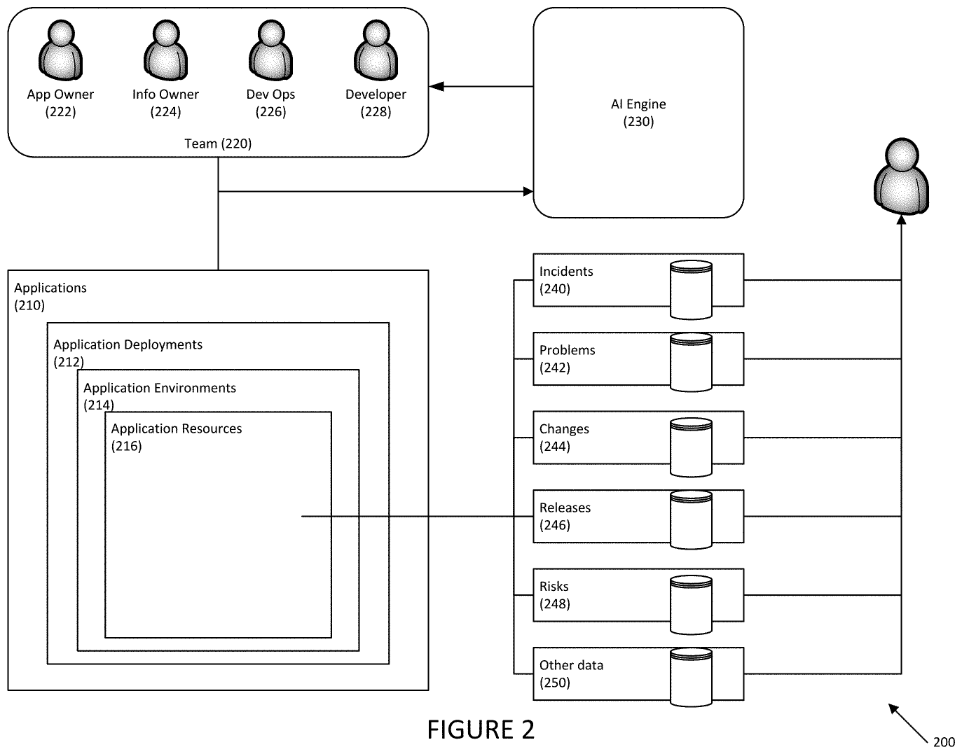

Referring to FIG. 2, a system for providing intelligent-based end-to-end delivery for an application is disclosed according to one embodiment. This may be from inception through operationalization, which may include release management into the multi-cloud estate. System 200 may include a plurality of applications 210, each of which may include application deployments 212, application environments 214, and application resources 216. Applications 210 may include an application entity/inventory. Application deployments 212, application environments 214, and application resources 216 may be derived from the control plane, from inception through operationalization.

Team 220 may include roles such as application owner 222, information owner 224, developer operations 226, and developer 228. In one embodiment, these personas or consumer types interact with system 200. Their roles, levels of access, and behaviors are based on their engagement with system 200. For example, application owner 222 has greater access to make changes, view insights than developer 228.

Each member of team 220 may have a role that dictates the functional capabilities they have access to in the system. For example, application owner 222 may have a broad view and may transact (new services), while developer 228 may only be able to schedule deployments.

In one embodiment, team 220 may be associated with one or more application 210 that may be used to filter the data at team 220′s disposal. This helps with both regulatory compliance and locating information. For example, the access and experience may be contextualized based on role, business affiliation, location, etc. This allows the platform to restrict services, actions, content/telemetry, financial data and applications to an individual.

Artificial intelligence (AI) engine 230 may receive information about applications 210, such as incidents 240, problems 242, changes 244, releases 246, risks 248, and other data 250. In embodiments, data may stream from various sources, SDLC tools (e.g., Jenkins for deployments), monitoring tools (e.g., New Relic, Dynatrace, Netcool, etc.), etc. Artificial intelligence engine 230 may aggregate, rationalize, and contextualize the data to provide meaning to the event streams. For example, a developer wants to schedule a change/deployment, and an event is occurring like an existing change or an incident. In a different setting, that change would proceed and cause impact. Embodiments prevent the change/deployment and the developer is notified of the reasons.

Artificial intelligence engine 230 may use these relationships to scan the mass of processes to filter out the noise and deliver actionable tasks. Embodiments may further rationalize events, and this may be tied to the application service mapping, asset inventory, and transactional details.

In embodiments, applications 210 may be organized in the manner in which team 220 develops them.

An example of an end-to-end process is as follows. When a user logs in, the user will interact at the UI layer, meaning that the user can either interact with all the telemetry that is presented based on the user's identity, or the user may transact (i.e., provision something, raise an incident, etc.). AI engine 230 is not directly visible or accessible to the consumer, it's working in the background.

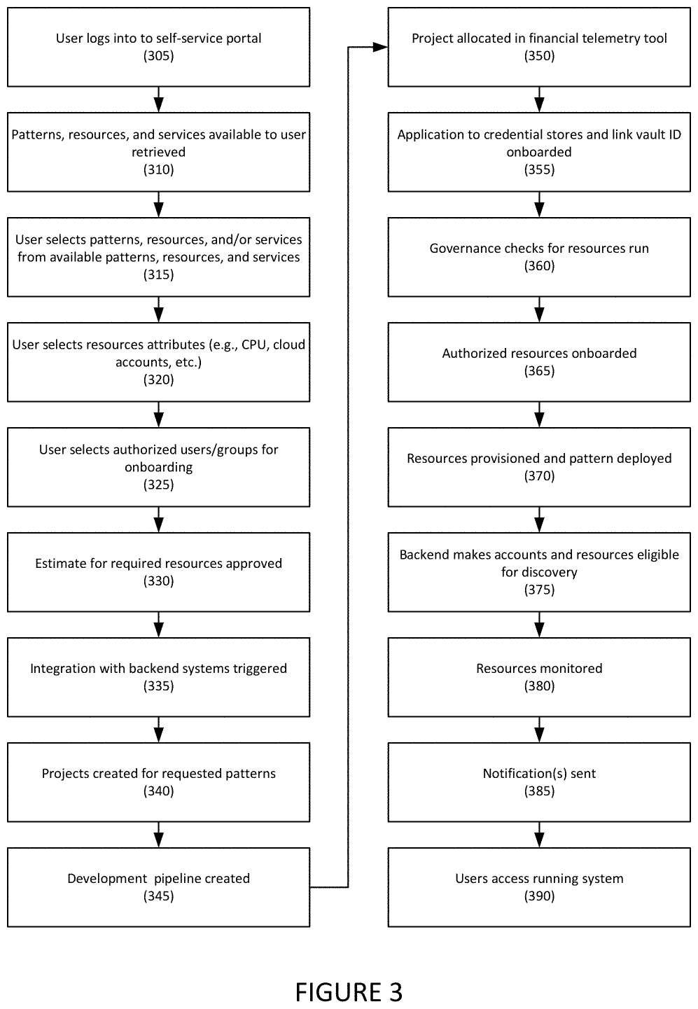

Referring to FIG. 3, an exemplary method for hybrid cloud delivery telemetry is disclosed according to one embodiment. In one embodiment, the method may be performed using one or more computer programs.

In step 305, a user or consumer may log in to a portal, such as a self-service portal. In one embodiment, as part of the login, the user may enter user credentials. In step 310, based on the credentials (e.g., entitlements, allowed access, etc.) and other factors (e.g., location, region, business unit, etc.), the backend may retrieve a catalog of patterns, resources, and services that are available to the user. The backend may present the catalog to the user.

Thus, embodiments may present the user with only the patterns, resources, and services that may be provisioned for the user in an active system. This provides benefits, including saving user time in requesting patterns, resources, and/or services that cannot be provisioned for the user; saving system resources in not having to restart the selection and provisioning process, etc. In addition, embodiments may provide a high degree of standardization, compliance, and risk mitigation. Embodiments may provide variability and flexibility in consumption based on a profile, inherent resiliency and embedded security controls.

In step 315, the user may select one or more pattern, resource, and/or service from the catalog.

In step 320, the user may select resource attributes, and in step 325, may select authorized users/groups for onboarding.

In step 330, the user may receive an estimate for required resources, and may receive approval for the estimate. The estimate may be derived from, for example, reference data of assets/services including the utilization and actuals charges to provide forecasts and estimates.

In one embodiment, the approval workflow may be automated.

In step 335, integration with backend systems may be triggered, including creating projects for the requested patterns in step 340, creating a new development pipeline (e.g., a Jules pipeline) that is linked to the projects in step 345, allocating the project in a financial telemetry tool to monitor costs and link accounts and resources in step 350, etc.

In step 355, the application(s) may be on-boarded to credential stores and may be linked to the vault ID and a privileged access management system. For example, the application(s) may be associated with the user's credentials (e.g., entitlements, allowed access, etc.).

In step 360, the backend may run governance checks for the resources in order to validate that the user is entitled to the resources and/or services.

In one embodiment, this may be optional if the governance checks were already performed as part of step 310. In another embodiment, the checks may be performed in step 310, and may be substantially continuously monitored for drift or change.

In step 365, authorized resources may be onboarded, and in step 370, the onboarded authorized resources maybe provisioned and the patterns may be deployed.

In step 375, the backend may add resources and/or accounts to CMDB, and may make them eligible for discovery. The resources may then be monitored in step 380, and notifications with resource details may be sent to the requesting and approving resources in step 385. The users may then access a running system with all resources/teams onboarded in step 390.

Although several embodiments have been disclosed, it should be recognized that these embodiments are not mutually exclusive, and features from one may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize any suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for hybrid cloud delivery telemetry, comprising:
receiving, by a computer program and from a user portal, a user identifier for a user, wherein the user identifier is associated with a set of entitlements for a plurality of patterns, a plurality of resources, and a plurality of services to which the user is authorized to access for a project;
retrieving, by the computer program and based on the user identifier, a subset of the plurality of patterns, a subset of the plurality of resources, and a subset of the plurality of services available to the user based on the set of entitlements associated with the user identifier;
presenting, by the computer program, the subset of the plurality of patterns, the subset of the plurality of resources, and the subset of the plurality of services to the user for selection;
receiving, by the computer program and from the user portal, a selection of one of the patterns, one of the resources, and/or one of the services from the user; and
provisioning, by the computer program, a user-specific system based on the selected pattern, the selected resource, and/or the selected service.

2. The method of claim 1, wherein the user identifier is further associated with a geography or region.

3. The method of claim 1, further comprising:
receiving, by the computer program, a selection of resource attributes for the selected resource.

4. The method of claim 1, further comprising:
receiving, by the computer program, a selection of authorized users or groups for onboarding;
wherein the authorized users or groups are granted access to the user-specific system.

5. The method of claim 1, further comprising:
generating, by the computer program, a cost estimate for the selected resources; and
receiving, by the computer program, approval for the cost estimate;
wherein the approval is received before the user-specific system is provisioned.

6. The method of claim 1, wherein the step of provisioning the user-specific system based on the selected pattern, the selected resource, and/or the selected service comprises:
initiating, by the computer program, interactions with data center systems and/or cloud systems to provision the selected pattern, the selected resource, and/or the selected service;
creating, by the computer program, projects for the selected pattern in response to the pattern being selected;
creating, by the computer program, a development pipeline that is linked to the project;
associating, by the computer program, the project with a financial telemetry tool to monitor costs for the project;
authorizing, by the computer program, the user to access the user-specific system;
onboarding, by the computer program, the selected pattern, the selected resource, and/or the selected service;
provisioning, by the computer program, the onboarded resources and deploying the onboarded pattern;
making, by the computer program, the provisioned resources and at least one account available for discovery; and
monitoring, by the computer program, use of the user-specific system.

7. An electronic device, comprising:
a memory storing a computer program; and
a computer processor;
wherein, when executed by the computer processor, the computer program causes the computer processor to:
receive, from a user portal, a user identifier for a user, wherein the user identifier is associated with a set of entitlements for a plurality of patterns, a plurality of resources, and a plurality of services to which the user is authorized to access for a project;
retrieve, based on the user identifier, a subset of the plurality of patterns, a subset of the plurality of resources, and a subset of the plurality of services available to the user based on the set of entitlements associated with the user identifier;
present the subset of the plurality of patterns, the subset of the plurality of resources, and the subset of the plurality of services to the user for selection;
receive, from the user portal, a selection of one of the patterns, one of the resources, and/or one of the services from the user; and
provision a user-specific system based on the selected pattern, the selected resource, and/or the selected service.

8. The electronic device of claim 7, wherein the user identifier is further associated with a geography or region.

9. The electronic device of claim 7, wherein the computer program further causes the computer processor to:
receive a selection of resource attributes in response to the resource being selected.

10. The electronic device of claim 7, wherein the computer program further causes the computer processor to:
receive a selection of authorized users or groups for onboarding;
wherein the authorized users or groups are granted access to the user-specific system.

11. The electronic device of claim 7, wherein the computer program further causes the computer processor to:
generate an estimate for the selected resources; and
receive approval for the estimate;
wherein the approval is received before the user-specific system is provisioned.

12. The electronic device of claim 7, wherein the computer program further causes the computer processor to provision the user-specific system based on the selection of the pattern, the resource, and/or the service by causing the computer processor to:
initiate interactions with data center systems and/or cloud systems to provision the selected pattern, the selected resource, and/or the selected service;
create projects for the selected pattern in response to the pattern being selected;
create a development pipeline that is linked to the project;
associate the project with a financial telemetry tool to monitor costs for the project;
authorize the user to access the user-specific system;
onboard the selected pattern, the selected resource, and/or the selected service;
provision the onboarded resources and deploying the onboarded pattern;
make the provisioned resources and at least one account available for discovery; and
monitor use of the user-specific system.

13. A system, comprising:
an entitlements library comprising a plurality of user identifiers, each user identifier associated with a set of entitlements for a plurality of patterns, a plurality of resources, and a plurality of services that the user identifier is authorized to access for a project;
a pattern library comprising a plurality of patterns;
a resource library comprising a plurality of resources;
a services library comprising a plurality of services;
a user portal that: receives a user identifier, retrieves the set of entitlements that are associated with the user identifier from the entitlements library; retrieves the plurality of patterns, the plurality of resources, and the plurality of services associated with the set of entitlements from the pattern library, the resource library, and the services library, respectively; present the plurality of patterns, the plurality of resources, and the plurality of services to the user for selection; and receives a selection of one of the patterns, one of the resources, and/or one of the services from the user; and
a computer program executed by a computer processor that causes the computer program to provision a user-specific system based on the selected pattern, the selected resource, and/or the selected service.

14. The system of claim 13, wherein the user identifier is further associated with a geography or region.

15. The system of claim 13, wherein the computer program further causes the computer processor to receive a selection of resource attributes in response to the resource being selected.

16. The system of claim 13, wherein the computer program further causes the computer processor to receive a selection of authorized users or groups for onboarding;
wherein the authorized users or groups are granted access to the user-specific system.

17. The system of claim 13, wherein the computer program further causes the computer processor to:
generate an estimate for the selected resources; and
receive approval for the estimate;
wherein the approval is received before the user-specific system is provisioned.

18. The system of claim 13, wherein the computer program further causes the computer processor to provision the user-specific system based on the selection of the pattern, the resource, and/or the service by causing the computer processor to:
initiate interactions with data center systems and/or cloud systems to provision the selected pattern, the selected resource, and/or the selected service;
create projects for the selected pattern in response to the pattern being selected;
create a development pipeline that is linked to the project;
associate the project with a financial telemetry tool to monitor costs for the project;
authorize the user to access the user-specific system;
onboard the selected pattern, the selected resource, and/or the selected service;
provision the onboarded resources and deploying the onboarded pattern;
make the provisioned resources and at least one account available for discovery; and
monitor use of the user-specific system.
